(19) United States
(12) Patent Application Publication
(10) Pub. No.: US 2024/0320535 A1
(43) Pub. Date: Sep. 26, 2024

(54) Quantum Circuitry Learning Method, Quantum Circuitry Learning System, and Quantum-Classical Hybrid Neural Network

(71) Applicant: KABUSHIKI KAISHA TOSHIBA, Tokyo (JP)

(72) Inventors: Yasutaka NISHIDA, Tama Tokyo (JP); Fumihiko AIGA, Kawasaki Kanagawa (JP)

(73) Assignee: KABUSHIKI KAISHA TOSHIBA, Tokyo (JP)

(21) Appl. No.: 18/502,365

(22) Filed: Nov. 6, 2023

(30) Foreign Application Priority Data
Mar. 23, 2023 (JP) 2023-046701

(51) Int. Cl. G06N 10/60

(52) U.S. Cl. CPC G06N 10/60

(57) ABSTRACT

A quantum circuitry learning method comprising: reading an optimized parameter θ* assigned to a parameterized quantum circuitry U(θ*) of a trained first HQCNN, the first HQCNN being trained based on a first data set regarding classical data b1; transferring the parameter θ* to a second feature extraction circuitry F (b2, θ*) included in a second HQCNN; training the second HQCNN based on a second data set regarding the classical data b2 while fixing the parameter θ*, and optimizing a second parameter Φ of a parameterized quantum circuitry U(Φ) of the second HQCNN.

### CROSS-REFERENCE TO RELATED APPLICATIONS

This application is based upon and claims the benefit of priority from Japanese Patent Application No. 2023-046701, filed Mar. 23, 2023, the entire contents of which are incorporated herein by reference.

### FIELD

Embodiments described herein relate generally to a quantum circuitry learning method, a quantum circuitry learning system, and a quantum-classical hybrid neural network

### BACKGROUND

In recent years, the development of gate-type quantum computers has progressed significantly, and quantum computing using quantum properties can be implemented by various methods although it is on a small scale. Such a device that performs quantum computing is called a noisy intermediate scale quantum (NISQ) device, and is regarded as an important first step of a milestone for a quantum computer that implements future error correction. Research utilizing NISQ devices is currently actively conducted. In particular, an algorithm called variational quantum eigensolver (VQE) is expected to be applied to quantum chemistry computing as a method for hybridizing and utilizing a quantum computer and a classical computer. However, there are many problems in implementing the VQE for practical problems such as drug discovery and material development. Specifically, in order to obtain a highly accurate result with the VQE, it is necessary to alternately perform measurement sampling in an NISQ device and a classical computer a large number of times. Conventionally, it has been proposed that a part of a final layer including a measurement layer of a quantum circuitry is removed, and the remaining circuitry is used for transfer learning. This is quantum machine learning in the category of linear operation in which measurement is performed in the final layer. In this method, learning cost is high to obtain a highly accurate result.

### BRIEF DESCRIPTION OF THE DRAWINGS

FIG. 1 is a block diagram illustrating an example of a configuration of a quantum circuitry learning system.

FIG. 2 is a diagram illustrating an exemplary circuitry configuration of an HQCNN.

FIG. 3 is a diagram illustrating an example of a processing procedure of quantum circuitry learning.

FIG. 4 is a diagram schematically illustrating processing of training a first HQCNN in step S1 illustrated in FIG. 3.

FIG. 5 is a diagram illustrating an example of a configuration of a parameterized quantum circuitry layer U(θ) in a case where the number n of qubits=4.

FIG. 6 is a diagram illustrating an example of the configuration of the parameterized quantum circuitry layer U(θ) in a case where the number n of qubits=5.

FIG. 7 is a diagram schematically illustrating transfer processing executed in step S4 illustrated in FIG. 3 and processing of training a second HQCNN in step S5.

FIG. 8 is a graph illustrating numerical simulation results for an H₂ molecule according to Example 1.

FIG. 9 is a graph illustrating numerical simulation results for a LiH molecule according to Example 1.

FIG. 10 is a graph illustrating numerical simulation results according to a comparative example corresponding to FIG. 9.

FIG. 11 is a graph illustrating numerical simulation results according to Example 2.

FIG. 12 is a graph illustrating numerical simulation results of an HQCNN according to a comparative example corresponding to FIG. 11.

FIG. 13 is a graph illustrating numerical simulation results according to Example 3.

FIG. 14 is a graph illustrating other numerical simulation results according to Example 3.

### DETAILED DESCRIPTION

In a series of studies for reducing the calculation cost of the VQE, in 2020, Xia & Kais et al. proposed a hybrid quantum-classical neural network (HQCNN) capable of estimating a potential energy surface (PES) of a ground state of a small molecule with high accuracy. The HQCNN is a method of configuring a surrogate model of the VQE that substitutes a conventional VQE calculation procedure with a neural network using quantum circuitry, and has a feature that a measurement layer is interposed therebetween. Specifically, by applying the HQCNN to quantum chemistry computing for chemical reaction analysis, variational optimization for each molecular structure, which is conventionally required in PES calculation using VQE, becomes unnecessary, and high-accuracy PES inference can be performed at low cost. However, since the number of parameters of the quantum circuitry to be optimized at the time of learning is large, the HQCNN has a high learning cost. (Non-Patent Literature: R. Xia and S. Kais, “Hybrid Quantum-Classical Neural Network for Calculating Ground State Energies of Molecules” Entropy 22, 828 (2020))

A quantum circuitry learning method according to an embodiment includes a reading step, a transfer step, and a training step. The reading step is a step of reading an optimized first parameter assigned to a first feature extraction circuitry included in a trained first quantum circuitry for a first task. The first quantum circuitry is trained based on a first data set regarding first classical data that is an explanatory variable, and the first feature extraction circuitry includes: a parameterized quantum circuitry having an encoding gate for encoding the first classical data and a quantum operation gate for performing a quantum operation according to the first parameter on a qubit; and a measurement layer for outputting first measured data of the qubit. The transfer step is a step of transferring the first parameter to a second feature extraction circuitry included in a second quantum circuitry for a second task. The second feature extraction circuitry includes: a parameterized quantum circuitry having an encoding gate for encoding second classical data representing an explanatory variable common to the first classical data and a quantum operation gate for performing a quantum operation according to the first parameter on the qubit; and a measurement layer for outputting second measured data of the qubit. The training step is a step of training the second quantum circuitry based on a second data set regarding the second classical data while fixing the first parameter transferred to the second feature extraction circuitry, and optimizing a second parameter of a task-specific circuitry subsequent to the second feature extraction circuitry and included in the second quantum circuitry. The task-specific circuitry includes a parameterized quantum circuitry having an encoding gate for encoding the second measured data and a quantum operation gate for performing a quantum operation according to the second parameter on the qubit.

Hereinafter, a quantum circuitry learning method, a quantum circuitry learning system, and a quantum-classical hybrid neural network according to the present embodiment will be described with reference to the drawings.

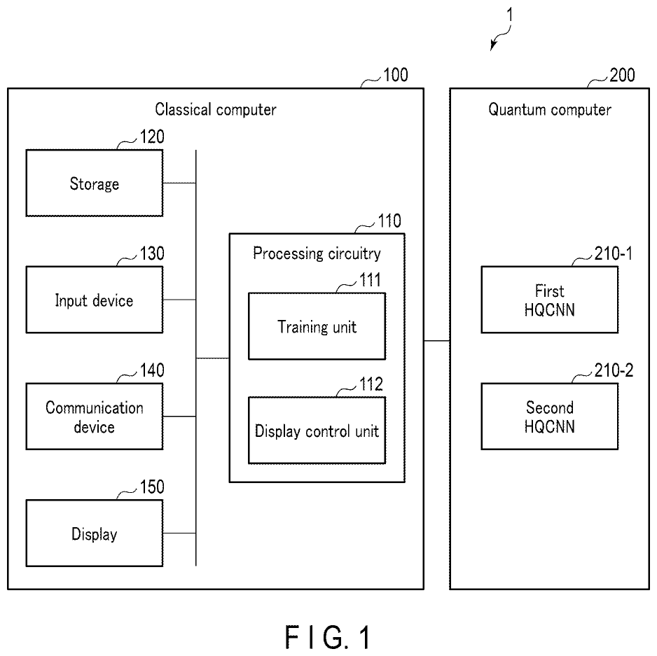

FIG. 1 is a block diagram illustrating an example of a configuration of the quantum circuitry learning system 1 according to the present embodiment. As illustrated in FIG. 1, the quantum circuitry learning system 1 includes a classical computer 100 and a quantum computer 200. The classical computer 100 and the quantum computer 200 are connected to each other so as to be able to communicate information with each other by wire or wirelessly.

The classical computer 100 is a computer that processes binary classical bits. The classical computer 100 is a computer including a processing circuitry 110, a storage 120, an input device 130, a communication device 140, and a display 150. Information communication is performed between the processing circuitry 110, the storage 120, the input device 130, the communication device 140, and the display 150 via a bus. Note that the storage 120, the input device 130, the communication device 140, and the display 150 are not essential components, and can be omitted as appropriate.

The processing circuitry 110 includes a processor such as a central processing unit (CPU) and a memory such as a random access memory (RAM). The processing circuitry 110 comprehensively controls the classical computer 100. The processing circuitry 110 includes a training unit 111 and a display control unit 112. The processing circuitry 110 implements each function of each of the units 111 and 112 by executing a quantum circuitry learning program. The quantum circuitry learning program is stored in a non-transitory computer-readable storage medium implemented by the storage 120 or the like. The quantum circuitry learning program may be implemented as a single program that describes all the functions of the units 111 and 112 described above, or may be implemented as a plurality of modules divided into several functional units. Each of the units 111 and 112 may be implemented by an integrated circuitry such as an application specific integrated circuitry (ASIC) or a field programmable gate array (FPGA). In this case, the units 111 and 112 may be mounted on a single integrated circuitry, or may be individually mounted on a plurality of integrated circuits.

The training unit 111 executes quantum circuitry learning for a quantum-classical hybrid neural network (HQCNN) 210 installed in the quantum computer 200. The HQCNN 210 has a first HQCNN 210-1 for a first task and a second HQCNN 210-2 for a second task. Hereinafter, in a case where the first HQCNN 210-1 and the second HQCNN 210-2 are not distinguished from each other, the HQCNN 210-1 and 210-2 are referred to as an HQCNN 210. For the quantum circuitry learning, the training unit 111 acquires a training data set. The training data set includes a plurality of training samples. Each training sample includes classical data as input data and teacher data corresponding to the classical data. The training unit 111 provides the classical data to the HQCNN 210. The classical data is converted into output data by the HQCNN 210. The training unit 111 trains the HQCNN 210 based on a difference between the output data and the teacher data, and optimizes parameters of the HQCNN 210.

The display control unit 112 causes the display 150 to display various types of information. For example, the display control unit 112 displays the classical data, the output data, the teacher data, and the like.

The storage 120 includes a read only memory (ROM), a hard disk drive (HDD), a solid state drive (SSD), an integrated circuitry storage, or the like. The storage 120 stores the quantum circuitry learning program and the like.

The input device 130 inputs various commands from an operator. As the input device 130, a keyboard, a mouse, various switches, a touch pad, a touch panel display, and the like can be used. An output signal from the input device 130 is supplied to the processing circuitry 110. Various commands from the operator may be input not by the input device 130 included in the classical computer 100 but by an input device provided in another classical computer connected via the communication device 140.

The communication device 140 is an interface for performing information communication with an external device such as the quantum computer 200 connected to the classical computer 100 by wire or wirelessly.

The display 150 displays various types of information under control by the display control unit 112. As the display 150, a cathode-ray tube (CRT) display, a liquid crystal display, an organic electroluminescence (EL) display, a light-emitting diode (LED) display, a plasma display, or any other display known in the art can be appropriately used. Furthermore, the display 150 may be a projector.

The quantum computer 200 is a computer including a quantum-classical hybrid neural network (HQCNN) 210 that performs a quantum gate operation on a plurality of qubits. The quantum computer 200 executes quantum computing using the HQCNN 210. As a method of implementing a qubit and a quantum gate by the HQCNN 210, any method such as a superconducting circuitry method, an ion trap method, a quantum dot method, or an optical lattice method may be used. It is assumed that the quantum computer 200 has various types of hardware for implementing an environment according to the method of implementing a qubit and a quantum gate. Although not illustrated in FIG. 1, the quantum computer 200 may include a storage, an input device, a communication device, a display, and the like in addition to a processing circuitry for performing various types of information processing using classical bits. The quantum computer 200 is an example of a quantum computing unit.

The quantum computer 200 receives classical data as input data from the classical computer 100, and inputs the classical data to the HQCNN 210 that performs a quantum gate operation on a plurality of qubits. The HQCNN 210 converts the classical data into output data. The quantum computer 200 acquires the output data from the HQCNN 210. The quantum computer 200 transmits the acquired output data to the classical computer 100.

The first HQCNN 210-1 is a quantum-classical hybrid neural network trainable for the first task, and includes a feature extraction circuitry assigned with an optimizable parameter θ for the first task, and a task-specific circuitry subsequent to the feature extraction circuitry and assigned with an optimizable parameter Q for the first task. The feature extraction circuitry includes a parameterized quantum circuitry having an encoding gate for encoding first classical data as an explanatory variable and a quantum operation gate for performing a quantum operation according to the parameter θ on a qubit, and a measurement layer for outputting measured data of the qubit. The task-specific circuitry includes a parameterized quantum circuitry having an encoding gate for encoding the measured data and a quantum operation gate for performing a quantum operation according to the parameter Θ on the qubit, and an output layer for outputting output data representing a quantum state of the qubit.

The second HQCNN 210-2 is a quantum-classical hybrid neural network trainable for a second task different from the first task, and includes a feature extraction circuitry extracted from the trained first HQCNN 210-1 for the first task and assigned with a parameter θ* optimized for the first task, and a task-specific circuitry subsequent to the feature extraction circuitry and assigned with a parameter Φ optimizable for the second task. The feature extraction circuitry includes a parameterized quantum circuitry having an encoding gate for encoding second classical data as an explanatory variable and a quantum operation gate for performing a quantum operation according to the parameter θ* on the qubit, and a measurement layer for outputting measured data of the qubit. The task-specific circuitry includes a parameterized quantum circuitry having an encoding gate for encoding the measured data and a quantum operation gate for performing a quantum operation according to the parameter Φ on the qubit, and an output layer for outputting output data representing a quantum state of the qubit.

The training unit 111 according to the present embodiment performs a training (hereinafter, first training) step on the first HQCNN 210-1 for the first task and a training (hereinafter, second training) step on the second quantum circuitry for the second task. In the first training step, the training unit 111 optimizes the parameter θ of the feature extraction circuitry 220 included in the HQCNN 210-1 and the parameter Θ of the task-specific circuitry 230 included in the HQCNN 210-1.

In a second training step, the training unit 111 trains the second HQCNN 210-2 by quantum transfer learning using the trained first HQCNN 210-1. Specifically, the second training step includes a reading step, a transfer step, and a training step. In the reading step, the training unit 111 reads the optimized parameter θ* assigned to the feature extraction circuitry included in the trained first HQCNN 210-1 for the first task. In the transfer step, the training unit 111 transfers the optimized parameter θ* to the feature extraction circuitry included in the second HQCNN 210-2 for the second task. In the training step, the training unit 111 trains the second HQCNN 210-2 based on the second data set regarding the second classical data while fixing the optimized parameter θ* transferred to the feature extraction circuitry included in the second HQCNN 210-2, and optimizes the parameter Φ of the task-specific circuitry subsequent to the feature extraction circuitry in the second HQCNN 210-2.

In the first training step or the second training step, the training unit 111 optimizes the parameter θ or the parameter Φ using the Nelder-Mead method, the Powell's method, the CG method, the Newton's method, the BFGS method, the L-BFGS-B method, the TNC method, the COBYLA method, and/or the SLSQP method using the classical computer.

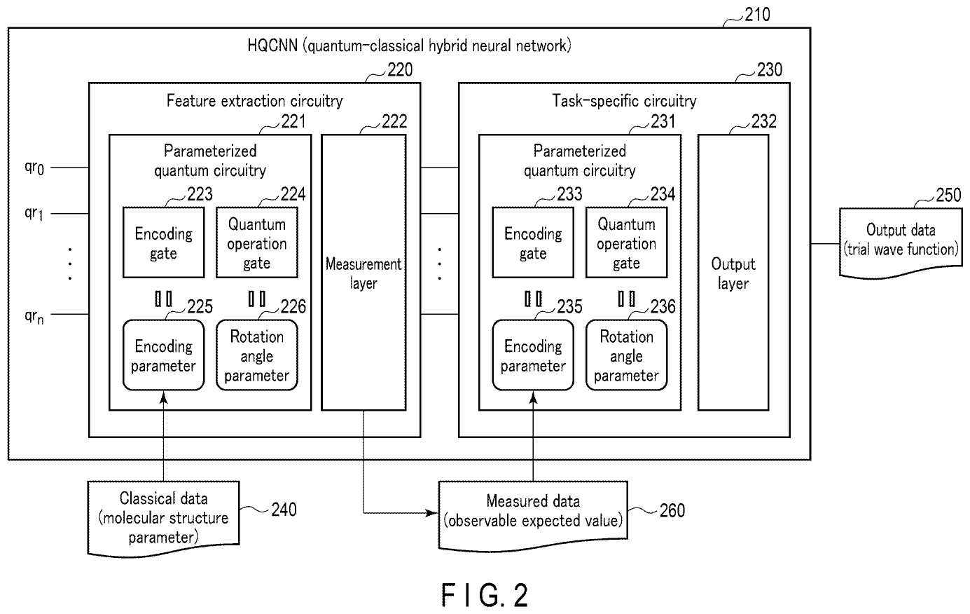

Next, circuitry configurations of the first HQCNN 210-1 and the second HQCNN 210-2 will be specifically described with reference to FIG. 2. Since the circuitry configurations of the first HQCNN 210-1 and the second HQCNN 210-2 are substantially the same, they are not distinguished from each other, and the HQCNN 210 is illustrated in FIG. 2.

FIG. 2 is a diagram illustrating an exemplary circuitry configuration of the HQCNN 210. The HQCNN 210 is a sequence of quantum circuitry including a sequence of quantum gates controlled by circuit parameters. As illustrated in FIG. 2, the HQCNN 210 includes n (n is a natural number of 2 or more) qubits. n may be appropriately set according to the scale such as the number of atoms, the number of electrons, and the number of spin orbitals of a molecule to be processed. The HQCNN 210 performs a quantum operation according to classical data 240 on the n qubits to construct an initial quantum state, performs a quantum operation according to a circuit parameter on the initial quantum state to construct an output quantum state, and outputs output data 250 according to the output quantum state.

As illustrated in FIG. 2, the HQCNN 210 includes a feature extraction circuitry 220 and a task-specific circuitry 230 subsequent to the feature extraction circuitry 220. The feature extraction circuitry 220 is a quantum circuitry including a parameterized quantum circuitry 221 and a measurement layer 222 subsequent to the parameterized quantum circuitry 221. The parameterized quantum circuitry 221 includes a sequence of an encoding gate 223 and a sequence of a quantum operation gate 224. The encoding gate 223 is a quantum gate to which an encoding parameter 225 for encoding the classical data 240 is assigned. The encoding parameter 225 is a type of circuit parameter, but is not a target to be optimized by the quantum circuitry learning. The encoding parameter 225 is set to a value corresponding to the classical data 240. The quantum operation gate 224 is a quantum gate to which a rotation angle parameter 226 for performing a quantum rotation operation on the qubits is assigned. The measurement layer 222 outputs measured data 260 representing quantum states corresponding to the n qubits. The rotation angle parameter 226 controls the rotation angle of the quantum gate that performs the quantum rotation operation.

The feature extraction circuitry 221 having the above configuration performs a quantum operation on the n qubits by the encoding gate 223 to which the encoding parameter 225 corresponding to the classical data 240 is assigned, constructs a first initial quantum state, and transforms the first initial quantum state into an intermediate quantum state by the quantum operation gate 224 to which the rotation angle parameter 226 is assigned, and the measurement layer 222 outputs, as the measured data 260, an observable expected value defined by an arbitrary tensor product of a Pauli operator with respect to the intermediate quantum state constructed by the parameterized quantum circuitry 221.

The task-specific circuitry 230 is a quantum circuitry including a parameterized quantum circuitry 231 and an output layer 232 subsequent to the parameterized quantum circuitry 231. The parameterized quantum circuitry 231 includes a sequence of an encoding gate 233 and a sequence of a quantum operation gate 234. The encoding gate 233 is a quantum gate to which an encoding parameter 235 for encoding the measured data 260 output by the measurement layer 222 is assigned. The encoding parameter 235 is a circuit parameter, but is not a target to be optimized by the quantum circuitry learning. The encoding parameter 235 is set to a value corresponding to the measured data 260. The quantum operation gate 234 is a quantum gate to which a rotation angle parameter 236 for performing a quantum rotation operation on the qubits is assigned. The output layer 232 outputs the output data 250 representing quantum states corresponding to the n qubits. The rotation angle parameter 236 controls the rotation angle of the quantum gate that performs the quantum rotation operation.

The task-specific circuitry 230 having the above configuration performs a quantum operation on the n qubits by the encoding gate 233 to which the encoding parameter 235 corresponding to the measured data 260 is assigned, constructs a second initial quantum state, and transforms the second initial quantum state into an output quantum state by the quantum operation gate 234 to which the rotation angle parameter 236 is assigned, and the output layer 232 outputs the output data 250 representing the output quantum state. As the output data 250, a trial wave function represented by the output quantum state is output.

Each of the parameterized quantum circuitry 221 and the parameterized quantum circuitry 231 is implemented by a real-amplitude quantum circuitry or a particle preserving circuitry called an A gate. The particle preserving circuitry is an ansatz that preserves the number of particles between an input quantum state and the output quantum state. In the particle preserving circuitry, a Hartree-Fock state is used as the input quantum state. The Hartree-Fock state means a quantum state in a state in which electron orbitals are filled with electrons in order from an electron orbital having a low energy level. That is, each of the parameterized quantum circuitry 221 and the parameterized quantum circuitry 231 performs a quantum gate operation on the input Hartree-Fock state by the quantum operation gate controlled by the rotation angle parameter while preserving the number of particles. In a case where the particle preserving circuitry is adopted, the HQCNN 210 can have a circuitry configuration specialized for quantum chemistry computing with a Hartree-Fock state as an initial input, as compared with a highly versatile Non-Patent Literature (R. Xia and S. Kais, “Hybrid Quantum-Classical Neutral Network for Calculating Ground State Energies of Molecules” Entropy 22, 828 (2020)). As a result, it is possible to improve convergence in a system having a large number of atoms, to apply the system to an actual practical system, to reduce the number of circuit parameters, and to reduce the calculation cost of quantum circuitry learning associated therewith.

The feature extraction circuitry 220 and the task-specific circuitry 230 may have the same quantum gate configuration or different quantum gate configurations. Furthermore, the encoding gate 223 and the quantum operation gate 224 may be arranged in series or in parallel with respect to the flow of the qubits in the parameterized quantum circuitry 221. Furthermore, the repetitive structure of the encoding gate 223 and the quantum operation gate 224 may be a single repetitive structure as exemplified in FIG. 2 or a repetitive structure in which the encoding gate 223 and the quantum operation gate 224 are repeatedly arranged twice or more times. The parameterized quantum circuitry 221 may have a circuitry configuration in which the encoding gate 223 and the quantum operation gate 224 are repeatedly arranged twice or more in series. Note that “in series” means that block circuits of the encoding gate 223 and the quantum operation gate 224 are repeatedly arranged twice or more times from upstream to downstream of the qubits. The parameterized quantum circuitry 221 may have a circuitry configuration in which the encoding gate 223 and the quantum operation gate 224 are repeatedly arranged twice or more in series.

Next, an example of quantum circuitry learning for the first HQCNN 210-1 and the second HQCNN 210-2 by the quantum circuitry learning system 1 will be described. In the following description, it is assumed that the first task of the first HQCNN is calculation of ground state energy of a hydrogen molecule, and the second task of the second HQCNN is calculation of ground state energy of a lithium hydride molecule. It is assumed that the hydrogen molecule and the lithium hydride molecule are diatomic molecules, the number of electrons of each of the molecules is two, and the number of spin orbitals of each of the molecules is four.

Each of the first task and the second task is quantum chemistry computing by the variational quantum eigensolver (VQE), and specifically, is assumed to be a task of estimating a potential energy surface (PES) of the ground state of the molecule to be processed. In this case, as the classical data, a molecular structure parameter that is an explanatory variable defining the molecular structure of each of the molecules to be processed is used. As the molecular structure parameter, coordinates of each of atoms constituting each of the molecules to be processed, a distance (bond length) between the atoms, an angle (bond angle) between bonds, and the like are used. The number of atoms, the number of electrons, the number of spin orbitals, and the like of the molecular structure of each of the molecules to be processed can be arbitrarily set. Note that the first task and the second task are set to the same type of tasks.

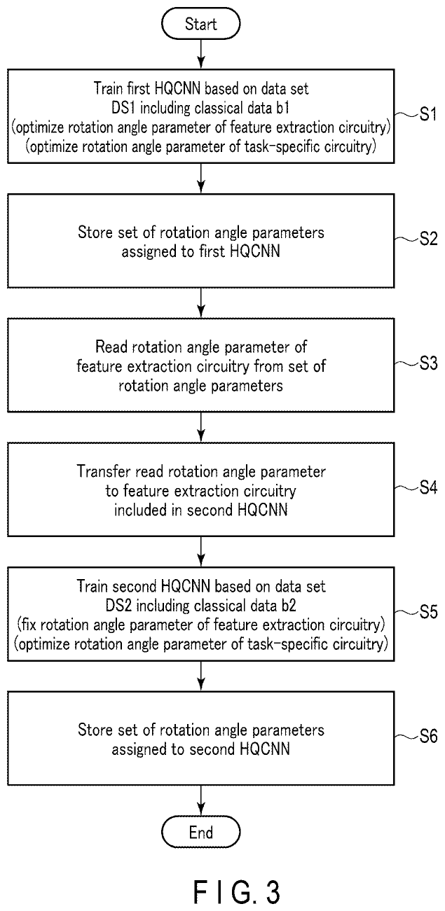

FIG. 3 is a diagram illustrating an example of a processing procedure of the quantum circuitry learning according to the present embodiment. As illustrated in FIG. 3, first, the training unit 111 trains the first HQCNN based on a data set DS1 including classical data b1 (step S1). It is assumed that the classical data b1 indicates an arbitrary hydrogen interatomic distance of the hydrogen molecule. The data set DS1 includes the hydrogen interatomic distance as the classical data b1 and an energy value of a ground state that corresponds to the hydrogen interatomic distance and is teacher data.

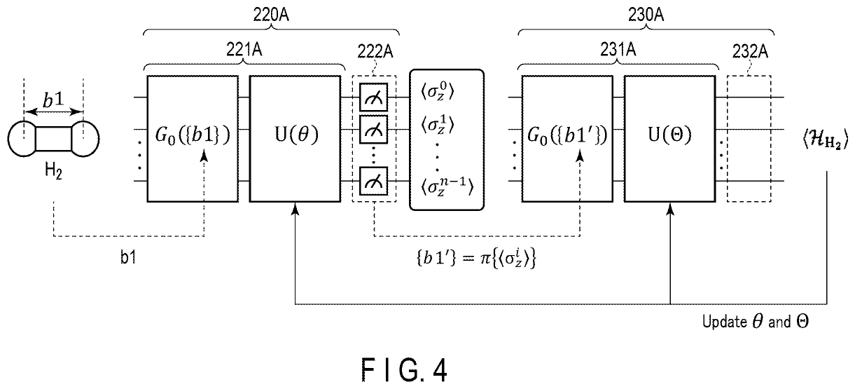

FIG. 4 is a diagram schematically illustrating processing of training the first HQCNN 210-1 in step S1. As illustrated in FIG. 4, the number of qubits of the first HQCNN 210-1 is 4. The first HQCNN 210-1 has a feature extraction circuitry 220A and a task-specific circuitry 230A. |0> is applied to the feature extraction circuitry 220A as an initial quantum state. The feature extraction circuitry 220A includes a parameterized quantum circuitry 221A and a measurement layer 222A, and the parameterized quantum circuitry 221A includes a data encoding layer G₀(b1) and a parameterized quantum circuitry layer U(θ). The data encoding layer G₀(b1) is a portion of the parameterized quantum circuitry 221A on which an encoding gate is implemented, and the parameterized quantum circuitry layer U(θ) is a portion of the parameterized quantum circuitry 221A on which a quantum operation gate is implemented.

The data encoding layer G₀(b1) has an encoding gate that encodes the classical data b1 into the feature extraction circuitry 220A. The mathematical expression of the encoding gate is expressed by the following Math (1) for a system of n qubits.

$$G = {⊗}_{i = 0}^{n - 1} {g}_{i} ( {f}_{i} ( {b}_{i} ) ) \qquad ( 1 )$$

Here, gᵢ represents a quantum gate (encoding gate) for one qubit, {bᵢ} represents general classical data, and fᵢ is a classical function that converts the classical data {bᵢ} into a parameter of a quantum gate gᵢ. As an example, the quantum gate gᵢ is represented by Ry ({bᵢ}) H as expressed by the following Math (2).

$${G}_{0} = {⊗}_{i = 0}^{n - 1} {R}_{y} ( \{ {b}_{i} \} ) H \qquad ( 2 )$$

The parameterized quantum circuitry layer U (e) performs a quantum rotation operation according to the rotation angle parameter θ on the qubits. The parameterized quantum circuitry layer U(θ) includes a single qubit gate and a two-qubit gate that entangles the qubits, such as a CNOT gate. The parameterized quantum circuitry layer U(θ) plays an important role in the representation capability of the first HQCNN 210-1, and the performance of the first HQCNN 210-1 depends greatly on the structure of the parameterized quantum circuitry layer U(θ). As a representative example of the first HQCNN 210-1, there is a real-amplitude quantum circuitry that causes a CX gate and an Ry gate to alternately act. The real-amplitude parameterized quantum circuitry layer U(θ) is expressed by the following Math (3) in a case where the number n of qubits is an odd number, and is expressed by the following Math (4) in a case where the number n of qubits is an even number.

$$U ( θ ) = {\prod }_{d = 1}^{D} ( {⊗}_{i = 0}^{n - 1} {R}_{y} ( {θ}_{i + n ( d - 1 )} ) ) ( {CX}_{n - 3 , n - 2} … {CX}_{1 , 2} ) ( C {X}_{n - 2 , n - 1} … {CX}_{0 , 1} ) \qquad ( 3 )$$

$$U ( θ ) = {\prod }_{d = 1}^{D} ( {⊗}_{i = 0}^{n - 1} {R}_{y} ( {θ}_{i + n ( d - 1 )} ) ) ( {CX}_{n - 2 , n - 1} … {CX}_{1 , 2} ) ( C {X}_{n - 3 , n - 2} … {CX}_{0 , 1} ) \qquad ( 4 )$$

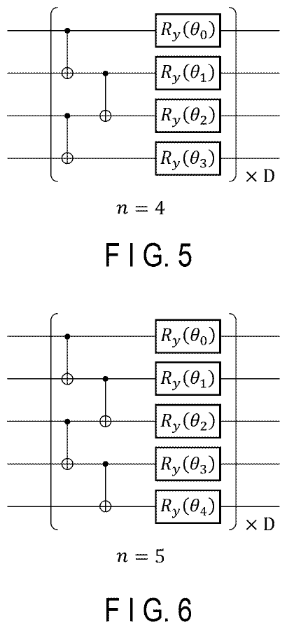

FIG. 5 is a diagram illustrating an example of a configuration of the parameterized quantum circuitry layer U(θ) in a case where the number n of qubits=4, and FIG. 6 is a diagram illustrating an example of a configuration of the parameterized quantum circuitry layer U(θ) in a case where the number n of qubits=5. As an example, a block circuitry (block circuitry surrounded by parentheses in FIG. 5) illustrated in FIG. 5 includes three CNOT gates and four Y-axis rotation gates that perform θ rotation about the Y-axis. A block circuitry (block circuitry surrounded by parentheses in FIG. 6) illustrated in FIG. 6 includes four CNOT gates and five Y-axis rotation gates that perform θ rotation about the Y-axis. D in each of FIGS. 5 and 6 means the depth of the circuitry that means the number of repetitions in units of the block circuitry illustrated in the drawing. The number of circuit parameters included in the parameterized quantum circuitry layer U(θ) in a case where the number of qubits is n and the depth is D is nD.

As illustrated in FIG. 4, the measurement layer 222A is sandwiched between the parameterized quantum circuitry U(θ) of the feature extraction circuitry 220A and the parameterized quantum circuitry U(Θ) of the task-specific circuitry 230A. The measurement layer 222A corresponds to an activation function in a classical neural network. In the measurement layer 222A, an expected value <σ_{z}ⁱ> of a Pauli Z matrix (Pauli-Z) of each qubit is measured using the first intermediate quantum state output from the preceding parameterized quantum circuitry.

The task-specific circuitry 230A includes a parameterized quantum circuitry 231A and a measurement layer 232A, and the parameterized quantum circuitry 231A includes a data encoding layer G ({b1′}) and a parameterized quantum circuitry layer U (Θ). |0> is applied as an initial quantum state to the task-specific circuitry 230A.

The data encoding layer G ({b1′}) has an encoding gate that encodes measured data {b1′} output by the measurement layer 222A into the task-specific circuitry 230A. More specifically, {b1′ }=π<σ_{z}ⁱ> obtained by multiplying the expected value <σ_{z}ⁱ> measured by the measurement layer 222A by n is substituted as a parameter of the data encoding layer G ({b1′}). The mathematical expression of the encoding gate of the data encoding layer G({b1′}) is obtained by replacing (b) of Math (1) with {b1′}.

The parameterized quantum circuitry layer U(Θ) performs a quantum rotation operation according to the rotation angle parameter Θ on the qubits. Similarly to the parameterized quantum circuitry layer U(θ), the parameterized quantum circuitry layer U(Θ) includes a single qubit gate and a two-qubit gate that entangles the qubits such as a CNOT gate. The mathematical expression of the parameterized quantum circuitry layer U(Θ) is obtained by replacing θ in Maths (3) and (4) with Θ.

The output layer 232 outputs, as output data, a trial wave function <H_{H2}> of an output quantum state constructed by the parameterized quantum circuitry layer U(Θ).

After a hydrogen interatomic distance {bᵢ} of the hydrogen molecule is given, the first HQCNN 210-1 illustrated in FIG. 4 calculates a quantum state according to the rotation angle parameter θ included in the preceding parameterized quantum circuitry U(θ) and the rotation angle parameter Θ included in the subsequent parameterized quantum circuitry U(Θ), and outputs an expected value of the quantum state. After the hydrogen interatomic distance {bᵢ} is given, the Hamiltonian of the hydrogen molecule can be transformed into a qubit-Hamiltonian H defined by a tensor product of a Pauli matrix expressed by the following Math (5) using a Jordan-Wigner transformation [Jordan and Wigner (1928)] or some transformation methods [Bravi and Kitaev (2005); Seeley and Love (2012)].

$$ℋ = {\sum }_{P ∈ {\{ I , X , Y , Z \}}^{⊗ n}} {h}_{P} P \qquad ( 5 )$$

The energy of the hydrogen molecule can be calculated by causing the qubit-Hamiltonian to act on the output quantum state obtained from the first HQCNN 210-1. At this time, the energy of the hydrogen molecule with the hydrogen interatomic distance {bᵢ} is expressed by functions of the rotation angle parameters θ and Θ. Therefore, by variationally optimizing the rotation angle parameters θ and Θ for each hydrogen interatomic distance {bᵢ}, it is possible to obtain the first HQCNN 210-1 that estimates the energy and the quantum state in the ground state at an arbitrary hydrogen interatomic distance {bᵢ}.

The training unit 111 optimizes the rotation angle parameters θ and Θ of the first HQCNN 210A based on a difference between the output data from the output layer 232 and the teacher data corresponding to the classical data b1. Specifically, the training unit 111 calculates a loss function for evaluating a difference between the output data and the teacher data, and updates the rotation angle parameters θ and Θ according to a predetermined optimization method so as to minimize the loss function.

The cost function is defined by a sum of expected values of the Hamiltonian for the output quantum state for the number of samples of the input data. In a case where the number of samples of the interatomic distance is α and {bᵢ}={b₀, b₁, . . . b_{α-1}}, specifically, the loss function <L> is defined by the following Math (6).

$$〈 L 〉 = \frac{1}{α} {\sum }_{m = 0}^{α - 1} 〈 Ψ ( {b}_{m} ) \vert {U}^{†} ( θ ) ℋ ( {b}_{m} ) U ( θ ) \vert Ψ ( {b}_{m} ) 〉 \qquad ( 6 )$$

$$Ψ ( {b}_{m} ) 〉 = G ( \{ π 〈 {σ}_{z , m}^{i} 〉 \} ) \vert 0 〉$$

$$( {σ}_{z , m}^{i} 〉 = 〈 ψ ( {b}_{m} ) \vert {U}^{†} ( θ ) ( I ⊗ I … I ⊗ {\underbrace{Z}}_{ith} ⊗ I … I ⊗ I ) U ( θ ) \vert ψ ( {b}_{m} ) 〉$$

$$\vert ψ ( {b}_{m} ) 〉 = {G}_{0} ( {b}_{m} ) \vert 0 〉$$

As the optimization method, the Nelder-Mead method, the Powell's method, the CG method, the Newton's method, the BFGS method, the L-BFGS-B method, the TNC method, the COBYLA method, and/or the SLSQP method, or any other optimization method can be used. As the teacher data, a highly accurate energy expected value calculated based on the corresponding classical data is used. As the teacher data, for example, it is preferable to use an exact solution calculated by the classical computer based on the classical data according to an arbitrary high-accuracy algorithm such as a full configuration interaction method (FCI) or a complete active space CI (CASCI) method. Alternatively, an experimental result for the input data may be used as the teacher data.

After the rotation angle parameters are updated, the training unit 111 determines whether or not the optimization of the rotation angle parameters is to be ended. As an example, the training unit 111 determines whether or not a condition for stopping the optimization is satisfied. The stop condition can be set to any condition such as a condition that the number of times that the rotation angle parameters are updated has reached a predetermined number of times or that the function value of the loss function has reached a threshold value. In a case where the training unit 111 determines that the stop condition is not satisfied, that is, in a case where the training unit 111 determines that the optimization is not to be ended, the update processing is repeated for another sample. Then, in a case where the training unit 111 determines that the stop condition is satisfied, that is, in a case where the training unit 111 determines that the optimization of the rotation angle parameters is to be ended, the training unit 111 determines the rotation angle parameters set at the current stage as optimized parameters θ* and Θ*.

Note that for the first HQCNN 210-1 with n qubits and the depth D, the number of rotation angle parameters to be optimized is 2nD, and expected value calculation is required to be performed a times corresponding to the number of samples of the input {bᵢ}.

After step S1 is performed, the storage 120 stores the set of rotation angle parameters θ* and Θ* assigned to the first HQCNN (step S2). Each of the rotation angle parameters θ* and Θ* may be associated with a label indicating a hydrogen molecule that is a molecule to be learned.

After step S2 is performed, the training unit 111 reads the rotation angle parameter θ* of the feature extraction circuitry 220A from the set of the rotation angle parameters θ* and Θ* stored in step S2 (step S3). Step S3 may be started by giving an instruction to start quantum transfer learning. As an example, the instruction may be input by the operator via the input device 130. Alternatively, step S3 may be automatically started in response to the completion of step S1 or S2.

After step S3 is performed, the training unit 111 transfers the rotation angle parameter θ* read in step S3 to the feature extraction circuitry included in the second HQCNN 210-2 (step S4). After step S4 is performed, the training unit 111 trains the second HQCNN 210-2 based on data set DS2 including classical data b2 (step S5).

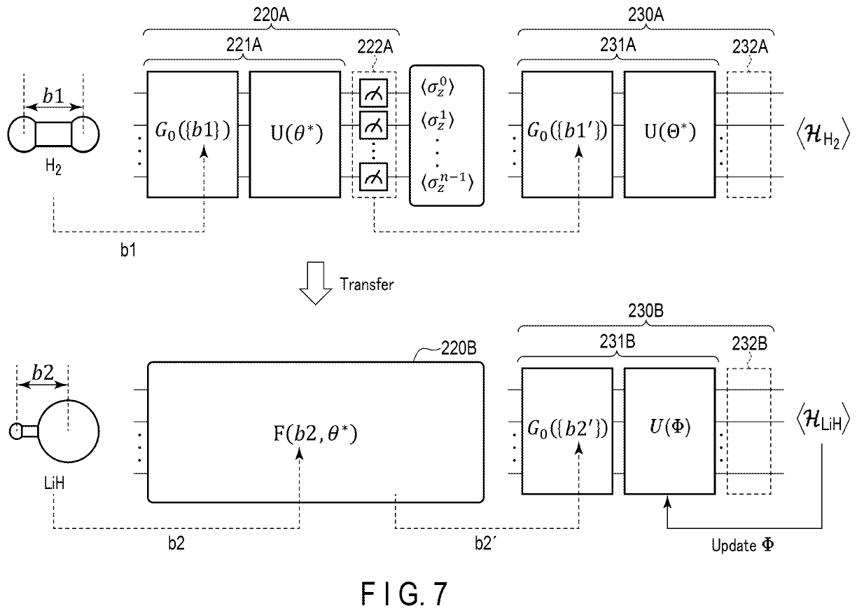

FIG. 7 is a diagram schematically illustrating the transfer processing executed in step S4 and the processing of training the second HQCNN in step S5. As illustrated in the upper part of FIG. 7, in step S1, the optimized rotation angle parameter θ* for the feature extraction circuitry included in the first HQCNN 210-1 and the optimized rotation angle parameter Θ* for the task-specific circuitry included in the first HQCNN 210-1 are obtained.

As illustrated in the lower part of FIG. 7, the second HQCNN 210-2 is prepared in the quantum computer 200. The second HQCNN 210-2 also has a circuitry configuration similar to that of the first HQCNN 210-1, that is, has a feature extraction circuitry and a task-specific circuitry. In step S4, the training unit 111 transfers the optimized rotation angle parameter θ* of the feature extraction circuitry included in the first HQCNN 210-1 to the feature extraction circuitry included in the second HQCNN 210-2. In other words, the feature extraction circuitry 220A included in the first HQCNN 210-1 is transferred to the second HQCNN 210-2.

As an example, the second HQCNN 210-2 learns the lithium hydride molecule LiH. The lithium hydride molecule is common to the hydrogen molecule in that they are diatomic molecules, but differ in one of the constituent atoms. Since the feature extraction circuitry 220B is expressed by the four qubits, the qubit-Hamiltonian of the lithium hydride molecule uses a two-electron two-orbital model. The classical data b2 is used as input data to the second HQCNN 210-2. The classical data b2 indicates the interatomic distance of the lithium hydride molecule, that is, the distance between hydrogen and lithium atoms.

The feature extraction circuitry F({b2}, θ*) of the second HQCNN 210-2 causes the encoding gate into which the classical data b2 was substituted to act on a qubit to construct a second initial quantum state, causes the quantum operation gate to which the rotation angle parameter θ* was assigned to act on the second initial quantum state to transform the quantum state into a second intermediate quantum state, and outputs a measured value (second measured data) b2′ of the second intermediate quantum state. Then, the task-specific circuitry G({b2′}) U (Φ) causes the data encoding layer G({b2′}) having the encoding gate into which the measured data b2′ was substituted to act on the qubit to construct a second initial quantum state, causes the parameterized quantum circuitry layer U (Φ) having the quantum operation gate to which the rotation angle parameter Φ was assigned to act on the second initial quantum state to transform the quantum state into a second output quantum state, and outputs a qubit-Hamiltonian (second output data) corresponding to the second output quantum state.

In step S5, the training unit 111 trains the second HQCNN 210-2 based on the data set DS2 including the classical data b2. Specifically, the training unit 111 trains the second HQCNN 210-2 while fixing the optimized rotation angle parameter θ* of the feature extraction circuitry F({b2}, θ*) to optimize the rotation angle parameter Φ of the task-specific circuitry G({b2′}) U (Φ) based on a difference between the second output data and the teacher data corresponding to the classical data b2. Here, the training unit 111 calculates a loss function for evaluating the difference between the output data and the teacher data, and updates the rotation angle parameter Φ according to the above optimization method so as to minimize the loss function. The loss function is obtained by replacing Θ in the above Math (6) with Φ and replacing θ with Θ*. Note that θ* is fixed in the training of the second HQCNN 210-2.

After the rotation angle parameter Φ is updated, the training unit 111 determines whether or not the optimization of the rotation angle parameter Φ is to be ended. As an example, the training unit 111 determines whether or not a condition for stopping the optimization is satisfied. The stop condition can be set to any condition such as a condition that the number of times that the rotation angle parameters are updated has reached a predetermined number of times or that the function value of the loss function has reached a threshold value. In a case where the training unit 111 determines that the stop condition is not satisfied, that is, in a case where the training unit 111 determines that the optimization is not to be ended, the update processing is repeated for another sample. Then, in a case where the training unit 111 determines that the stop condition is satisfied, that is, in a case where the training unit 111 determines that the optimization of the rotation angle parameter Φ is to be ended, the training unit 111 determines the rotation angle parameter set at the current stage as the optimized parameter Φ*. This completes the optimized second HQCNN 210-2.

The optimized second HQCNN 210-2 is a trained quantum-classical hybrid neural network for the second task and includes: the feature extraction circuitry that is extracted from the trained first HQCNN 210-1 for the first task different from the second task and to which the optimized parameter θ* is assigned for the first task; and the task-specific circuitry that is subsequent to the feature extraction circuitry and to which the optimized parameter Φ* is assigned for the second task. The feature extraction circuitry includes the parameterized quantum circuitry having the encoding gate for encoding classical data as an explanatory variable and the quantum operation gate for performing a quantum operation according to the parameter θ* on a qubit, and a measurement layer for outputting measured data of the qubit. The task-specific circuitry includes the parameterized quantum circuitry having the encoding gate for encoding the measured data and the quantum operation gate for performing a quantum operation according to the parameter Φ* on the qubit, and the output layer for outputting output data representing a quantum state of the qubit.

After step S5 is performed, the storage 120 stores the set of rotation angle parameters θ* and Φ* assigned to the second HQCNN 210-2 (step S6). Each of the rotation angle parameters θ* and Φ* may be associated with a label indicating the lithium hydride molecule that is a molecule to be learned.

As described above, the quantum circuitry learning for the first HQCNN 210-1 and the second HQCNN 210-2 by the quantum circuitry learning system 1 ends.

In a case where a feature extractor F in the quantum transfer learning is applied to the quantum chemistry computing as illustrated in FIG. 3, the feature extractor F can be regarded as a quantum circuitry that extracts a feature of the molecular structure from the hydrogen interatomic distance {bᵢ} as classical input information (classical data). For the second HQCNN 210-2 with n qubits and the depth D, the number of parameters to be optimized can be reduced from 2nD to nD by using the quantum circuitry learning method according to the present embodiment.

The quantum transfer learning according to the present embodiment can be used between different tasks using similar data structures of classical data as input data. The feature extractor F can extract, as abstracted information, a structure of a molecule to be processed that is given as classical data. Therefore, in the above embodiment, the feature extractor F is generated for the first HQCNN 210-1 based on the classical data regarding H₂ in which the molecule to be processed is a diatomic molecule, but the present embodiment is not limited thereto, and the feature extractor F may be generated based on another diatomic molecule. In addition, by generating the feature extractor F based on classical data regarding a polyatomic molecule of two or more atoms, the feature extractor F can extract a feature having a more complex structure. In the present embodiment, the feature extractor F thus obtained can be transferred to an HQCNN in which a task is quantum chemistry computing of molecules having similar molecular structures. In addition to quantum chemistry computing, the present invention is also applicable to materials informatics in which similar classical input information is input.

The quantum circuitry learning method according to the present embodiment targets not only measurement on the final layer but also an HQCNN in which a measurement layer is sandwiched between parameterized quantum circuitry, and uses a block circuitry including an intermediate measurement layer as transfer learning. As a result, it is possible to implement transfer learning of a quantum circuitry that implements nonlinear operation beyond a category of linear operation, and thus, it is possible to implement a quantum machine learning model with high accuracy particularly in quantum chemistry computing.

The quantum circuitry learning system 1 is an example, and a change, addition, and/or removal can be appropriately made in the quantum circuitry learning system 1 without departing from the gist of the invention. As an example, as illustrated in FIG. 1, the quantum circuitry learning system 1 includes the classical computer 100 and the quantum computer 200. However, the present embodiment is not limited thereto, and the classical computer 100 may be incorporated into the quantum computer 200, or the quantum computer 200 may be incorporated into the classical computer 100.

As another example, with reference to FIG. 2 and the like, the task-specific circuitry 220 includes the parameterized quantum circuitry 231 and the output layer 232, but one or a plurality of blocks of the parameterized quantum circuitry and the measurement layer may be connected between the parameterized quantum circuitry 231 and the output layer 232. In this case, the plurality of parameterized quantum circuitry are connected via a measured value of the immediately preceding measurement layer 222. This makes it possible to handle complex quantum chemistry computing.

Hereinafter, examples of the quantum chemistry computing according to the present embodiment will be described.

### Example 1

Molecules to be processed according to Example 1 are an H₂ molecule, a LiH molecule, and a HF molecule. Numerical simulation was performed using the electron Hamiltonian of these molecules. In Example 1, PySCF, which is an existing open source library (see Reference 1 (Q. Sun, T. C. Berkelbach, N. S. Blunt, G. H. Booth, S. Guo, Z. Li, J. Liu, J. D. McClain, E. R. Sayfutyarova, S. Sharma, S. Wouters, and G. K. Chan, Wiley Interdisciplinary Reviews: Computational Molecular Science 8, e1340 (2017)), and OpenFermion (see Reference 2 (J. R. McClean, K. J. Sung, I. D. Kivlichan, Y. Cao, C. Dai, E. S. Fried, C. Gidney, B. Gimby, P. Gokhale, T. Hner, T. Hardikar, V. Havlek, O. Higgott, C. Huang, J. Izaac, Z. Jiang, X. Liu, S. McArdle, M. Neeley, T. O'Brien, B. O′ Gorman, I. Ozdan, M. D. Radin, J. Romero, N. Rubin, N. P. D. Sawaya, K. Setia, S. Sim, D. S. Steiger, M. Steudtner, Q. Sun, W. Sun, D. Wang, F. Zhang, and R. Babbush, (2017), arXiv: 1710.07629.) were used to calculate the Hamiltonian. The simulation of the quantum circuitry was performed using Qiskit (Reference 3 (see G. Aleksandrowicz, T. Alexander, P. Barkoutsos, L. Bello, Y. Ben-Haim, D. Bucher, F. Jose Cabrera-Hernandez, J. Carballo-Franquis, A. Chen, C. Chen, J. Chow, A. Corcoles-Gonzales, A. Cross, A. Cross, A. Cross, J. Cruz-Benito, C. Culver, S. Gonzalez, E. Torre, D, Ding, E. Dumitrescu, I. Duran, P. Eendebak, M. Everitt, I. Sertage, A. Frisch, A. Fuhrer, J. Gambetta, B Gago, J. Gomez-Mosquera, D. Greenberg, I. Hamamura, V. Havlicek, J. Hellmers, L. Herok, H. Horii, S. Hu, T. Imamichi, T. Itoko, A. Javadi-Abhari, N. Kanazawa, A. Karazeev, K. Krsulich, P. Liu, Y. Luh, Y. Maeng, M. Marques, F. Martin-Fernandez, D. Mcclure, D. Mckay, S. Meesala, A. Mezzacapo, N. Moll, D. Rodriguez, G. Nannicini, P. Nation, P. Ollitrault, L. O'Riordan, H. Paik, J. Perez, A. Phan, M. Pistoia, V. Prutyanov, M. Reuter, J. Rice, A. Davila, R. Rudy, M. Ryu, N. Sathaye, C. Schnabel, E. Schoute, K. Setia, Y. Shi, A. Silva, Y. Siraichi, S. Sivarajah, J. Smolin, M. Soeken, H. Takahashi, I. Tavernelli, C. Taylor, P. Taylour, K. Trabing, M. Treinish, W. Turner, D. Vogt-Lee, C. Vuillot, J. Wildstrom, J. Wilson, E. Winston, C. Wood, S. Wood, S. Worner, I. Akhalwaya, C. Zoufalhttps.

https://doi.org/10.5281/zenodo.2562111, (2019) An Open-source Framework for Quantum Computing).

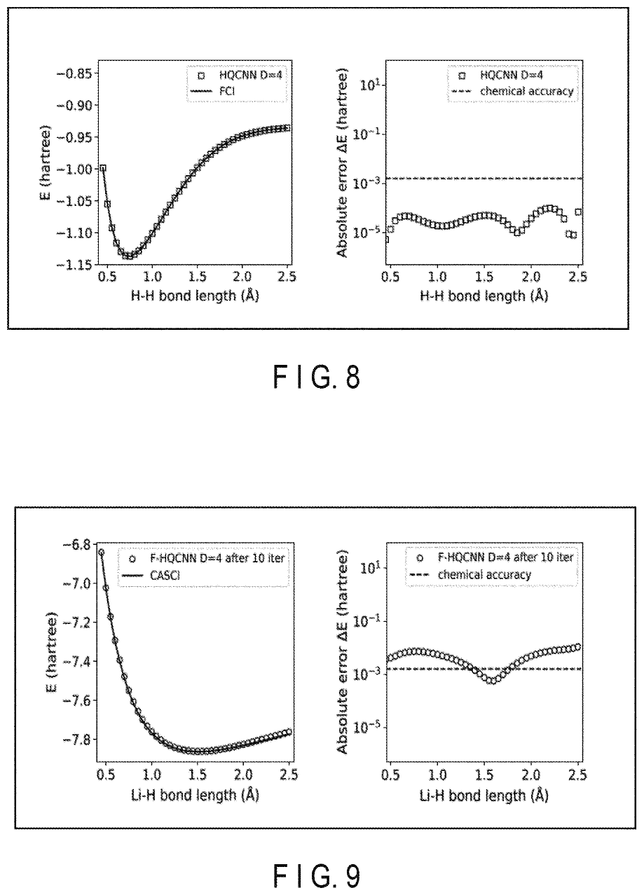

FIG. 8 is a graph illustrating numerical simulation results for the H₂ molecule according to Example 1. In the graph on the left side of FIG. 8, the vertical axis represents the potential energy E [hartree] of the ground state of the H₂ molecule, and the horizontal axis represents the bond length [Å] between the hydrogen atoms. In the graph on the right side of FIG. 8, the vertical axis represents an absolute error ΔE [hartree] of the ground state of the H₂ molecule, and the horizontal axis represents the bond length [Å] between the hydrogen atoms. Plots with squares represent the numerical simulation results for the ground state of the H₂ molecule using the first HQCNN in which n is set to 4 and D is set to 4. The number of iterations of variational optimization is 1000. The number of parameters to be optimized is 2nD=32. A solid line represents a full configuration interaction method (FCI) that is an exact solution. As illustrated in FIG. 8, an inference error falls below the chemical accuracy over the entire specified interatomic distance, and sufficient accuracy is obtained.

FIG. 9 is a graph illustrating numerical simulation results for the LiH molecule according to Example 1. In the graph on the left side of FIG. 9, the vertical axis represents the potential energy E [hartree] of the ground state of the LiH molecule, and the horizontal axis represents the bond length [Å] between the lithium atom and the hydrogen atom. In the graph on the right side of FIG. 9, the vertical axis represents an absolute error ΔE [hartree] of the ground state of the LiH molecule, and the horizontal axis represents the bond length [Å] between the lithium atom and the hydrogen atom. Plots with circles represent results of numerical simulations by the second HQCNN (denoted as F-HQCNN in the drawing) obtained by the transfer learning according to the present embodiment. The number of iterations of variational optimization is 10. The F-HQCNN has n=4 and D=4, and a feature extraction circuitry F extracted from the HQCNN obtained in FIG. 8 is used as the feature extraction circuitry of the F-HQCNN. The number of iterations is not particularly limited, and can be appropriately changed. For example, the number of iterations may be set in advance or adaptively according to the degree of convergence of a calculation error, the calculation time, and the like. In the present embodiment, it is preferable to perform the variational optimization about 10 times.

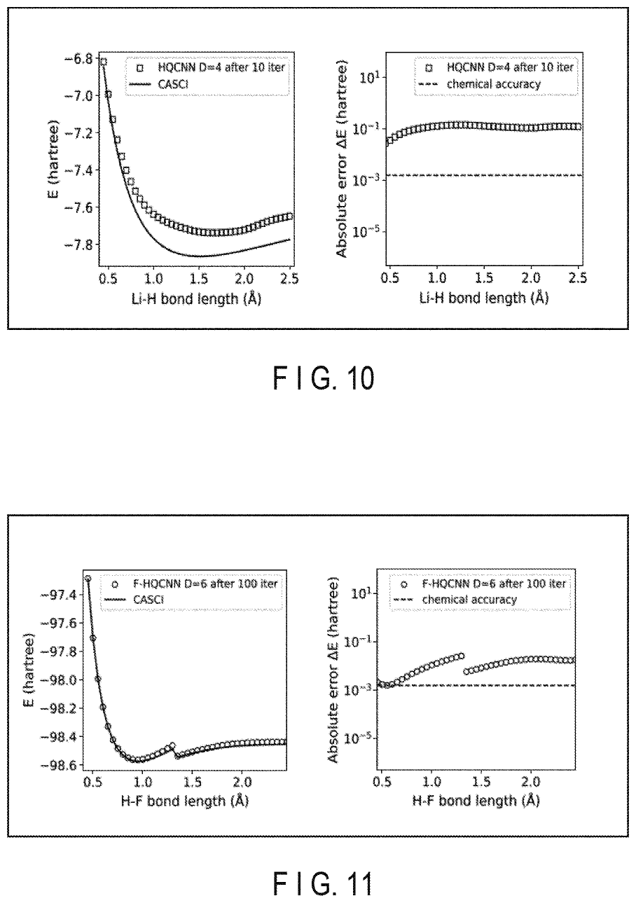

FIG. 10 is a graph illustrating numerical simulation results according to a comparative example corresponding to FIG. 9. Plots with circles illustrated in FIG. 10 represent results of numerical simulations by the HQCNN described in Non-Patent Literature in which transfer learning is not performed. The number of iterations of variational optimization is 10. As can be seen from the comparison between FIGS. 9 and 10, an error from a CASCI solution which is an exact solution in a two-electron two-orbital model is large in the HQCNN according to the comparative example, and the F-HQCNN according to the present embodiment is more accurately matched with the CASCI solution. Furthermore, in order to use the HQCNN according to the comparative example to perform learning to achieve accuracy similar to that of the F-HQCNN according to the present embodiment, variational optimization needs to be performed 100 times or more. Therefore, in the F-HQCNN according to the present embodiment, the number of times of variational optimization can be reduced by about one digit, and the learning cost can be reduced. Furthermore, in the F-HQCNN, since the number of parameters to be optimized is nD=16, the calculation cost required for one optimization can be reduced as compared with the HQCNN.

### Example 2

A molecule to be processed according to Example 2 is a hydrogen fluoride molecule (HF molecule).

FIG. 11 is a graph illustrating numerical simulation results according to Example 2. In the graph on the left side of FIG. 11, the vertical axis represents the potential energy E [hartree] of the ground state of the HF molecule, and the horizontal axis represents the bond length [Å] between the fluorine atom and the hydrogen atom. In the graph on the right side of FIG. 11, the vertical axis represents an absolute error ΔE [hartree] of the ground state of the HF molecule, and the horizontal axis represents the bond length [Å] between the fluorine atom and the hydrogen atom. Plots with circles represent results of numerical simulations using an F-HQCNN in which n is set to 4 and D is set to 6. The number of iterations of variational optimization is 100. Here, the F-HQCNN is a second HQCNN obtained by transferring the feature extractor obtained based on the hydrogen molecule described in Example 1. A solid line in the graph on the left side represents a CASCI solution, which is an exact solution, and the dotted line in the graph on the right side represents the chemical accuracy.

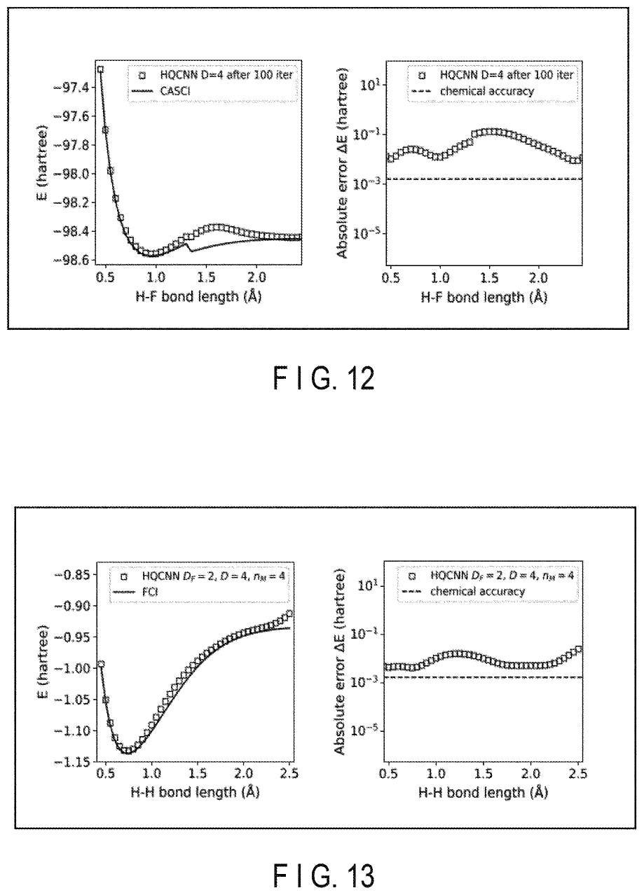

FIG. 12 is a graph illustrating numerical simulation results of an HQCNN according to a comparative example corresponding to FIG. 11. Plots with squares illustrated in FIG. 12 represent numerical simulation results obtained using the HQCNN according to the comparative example in which n=4 and D=6. The number of iterations of variational optimization is 100. As can be seen from the comparison between FIGS. 11 and 12, in the HQCNN according to the comparative example illustrated in FIG. 12, there is an interatomic distance region having a large error from the CASCI solution, whereas in the F-HQCNN according to the present embodiment illustrated in FIG. 11, inference can be accurately performed over the entire interatomic distance. Unlike hydrogen molecules, HF molecules have strong ionic bondability, and the bonding mode is different from that of hydrogen molecules. However, it is understood that a quantum machine learning model that accurately infers the PES of HF molecules can be obtained even if information of a quantum circuitry optimized based on a hydrogen molecule is diverted. As described above, it can be seen that a quantum machine learning model for predicting properties of a polyatomic molecular system and molecular systems having different bonding modes can be made by using information of a quantum circuitry based on the simplest hydrogen molecule. Transfer learning using conventional classical data is used in learning another special system at low cost using a part of a model trained using many data. The quantum transfer learning according to the present embodiment is different from conventional transfer learning in that a special system can be used to learn another special system.

### Example 3

In Example 3, in order to further reduce the calculation cost required for learning, the circuitry depth Dr of the parameterized quantum circuitry of the feature extraction circuitry in the first HQCNN (hereinafter, expressed as pre-HQCNN) that learns hydrogen molecules is reduced from 4 to 2. The circuitry depth of the parameterized quantum circuitry of the task-specific circuitry is D=4.

FIG. 13 is a graph illustrating numerical simulation results according to Example 3. In the graph on the left side of FIG. 13, the vertical axis represents the potential energy E [hartree] of the ground state of the H₂ molecule, and the horizontal axis represents the bond length [Å] between the hydrogen atoms. In the graph on the right side of FIG. 13, the vertical axis represents an absolute error ΔE [hartree] of the ground state of the H₂ molecule, and the horizontal axis represents the bond length [Å] between the hydrogen atoms. Plots with squares illustrated in FIG. 13 represent numerical simulation results of the HQCNN in which D_{F} is set to 2, D is set to 4 and n_{M} is set to 4. By reducing the Dr from 4 to 2, the number of parameters to be optimized is reduced from 32 to 24. Comparing FIG. 13 with FIG. 8, it can be seen that the accuracy in Example 3 in which D_{F}=2 is slightly reduced as compared with Example 1 in which D_{F}=4, but learning and inference can be performed with relatively high accuracy over the entire interatomic distance. Therefore, the circuitry depth of the parameterized quantum circuitry included in the feature extraction circuitry can be reduced according to the required accuracy.

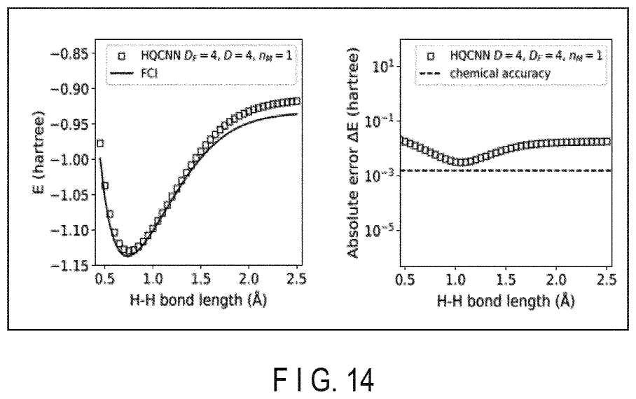

FIG. 14 is a graph illustrating other numerical simulation results according to Example 3. In the graph on the left side of FIG. 14, the vertical axis represents the potential energy E [hartree] of the ground state of the H₂ molecule, and the horizontal axis represents the bond length [Å] between the hydrogen atoms. In the graph on the right side of FIG. 14, the vertical axis represents an absolute error ΔE [hartree] of the ground state of the H₂ molecule, and the horizontal axis represents the bond length [Å] between the hydrogen atoms. Plots with squares illustrated in FIG. 14 represent numerical simulation results in a case where the number n_{M} of qubits in the measurement layer of the feature extraction circuitry is reduced from four qubits (n_{M}=4) to 1 qubit (n_{M}=1). Comparing FIG. 14 with FIG. 8, it can be seen that the accuracy in Example 3 in which n_{M}=1 is slightly reduced as compared with Example 1 in which n_{M}=4, but learning and inference can be performed with relatively high accuracy over the entire interatomic distance. Therefore, the number nm of qubits constituting the feature extraction circuitry can be reduced according to the required accuracy.

Thus, it is possible to provide a quantum circuitry learning method, a quantum circuitry learning system, and a quantum-classical hybrid neural network capable of reducing the calculation cost required for training.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A quantum circuitry learning method comprising:
reading an optimized first parameter assigned to a first feature extraction circuitry included in a trained first quantum circuitry for a first task, the first quantum circuitry being trained based on a first data set regarding first classical data as an explanatory variable, the first feature extraction circuitry including a parameterized quantum circuitry having an encoding gate for encoding the first classical data and a quantum operation gate for performing a quantum operation according to the first parameter on a qubit, and a measurement layer for outputting first measured data of the qubit;
transferring the first parameter to a second feature extraction circuitry included in a second quantum circuitry for a second task, the second feature extraction circuitry including a parameterized quantum circuitry having an encoding gate for encoding second classical data representing an explanatory variable common to the first classical data and a quantum operation gate for performing a quantum operation according to the first parameter on the qubit, and a measurement layer for outputting second measured data of the qubit;
training the second quantum circuitry based on a second data set regarding the second classical data while fixing the first parameter transferred to the second feature extraction circuitry, and optimizing a second parameter of a task-specific circuitry subsequent to the second feature extraction circuitry and included in the second quantum circuitry, the task-specific circuitry including a parameterized quantum circuitry having an encoding gate for encoding the second measured data and a quantum operation gate for performing a quantum operation according to the second parameter on the qubit.

2. The quantum circuitry learning method according to claim 1, further comprising: training the first quantum circuitry based on the first data set regarding the first classical data, and optimizing the first parameter assigned to the first feature extraction circuitry included in the first quantum circuitry.

3. The quantum circuitry learning method according to claim 1, wherein the parameterized quantum circuitry is a real-amplitude quantum circuitry or a quantum circuitry that preserves the number of particles.

4. The quantum circuitry learning method according to claim 3, wherein the quantum circuitry that preserves the number of particles performs a quantum operation on a Hartree-Fock state.

5. The quantum circuitry learning method according to claim 1, wherein the first parameter and/or the second parameter controls a rotation angle of a quantum gate that performs a quantum rotation operation.

6. The quantum circuitry learning method according to claim 1, wherein the second feature extraction circuitry and the task-specific circuitry have different quantum gate configurations.

7. The quantum circuitry learning method according to claim 1, wherein the measurement layer included in the first feature extraction circuitry and/or the measurement layer included in the second feature extraction circuitry outputs an observable expected value defined by an arbitrary tensor product of a Pauli operator for a quantum state constructed by the parameterized quantum circuitry as the first measured data and/or the second measured data.

8. The quantum circuitry learning method according to claim 1, wherein in the training, the second parameter is optimized using a Nelder-Mead method, a Powell's method, a CG method, a Newton's method, a BFGS method, an L-BFGS-B method, a TNC method, a COBYLA method, and/or an SLSQP method using a classical computer.

9. The quantum circuitry learning method according to claim 1, wherein the parameterized quantum circuitry has a circuitry configuration in which the encoding gate and the quantum operation gate are repeatedly arranged two or more times in series.

10. A quantum circuitry learning system comprising:
a quantum computer that applies classical data representing an explanatory variable to a first quantum circuitry and outputs output data corresponding to the classical data, the first quantum circuitry including a feature extraction circuitry to which an optimized first parameter is assigned, and a task-specific circuitry that is subsequent to the feature extraction circuitry and to which an optimizable second parameter is assigned, the feature extraction circuitry including a parameterized quantum circuitry having an encoding gate for encoding the classical data and a quantum operation gate for performing a quantum operation according to the first parameter on a qubit, and a measurement layer for outputting measured data of the qubit, and the task-specific circuitry including a parameterized quantum circuitry having an encoding gate for encoding the measured data and a quantum operation gate for performing a quantum operation according to the second parameter on the qubit, and an output layer for outputting output data representing a quantum state of the qubit; and
a classical computer that trains the first quantum circuitry based on a difference between the output data and teacher data corresponding to the classical data while fixing the first parameter of the feature extraction circuitry, and optimizes the second parameter of the task-specific circuitry.

11. A quantum-classical hybrid neural network trainable for a target task, comprising:
a feature extraction circuitry that is extracted from another quantum-classical hybrid neural network trained for another task different from the target task and to which a first parameter optimized for the other task is assigned; and
a task-specific circuitry that is subsequent to the feature extraction circuitry and to which a second parameter optimizable for the target task is assigned, wherein
the feature extraction circuitry includes a parameterized quantum circuitry having an encoding gate for encoding first classical data as an explanatory variable and a quantum operation gate for performing a quantum operation according to the first parameter on a qubit, and a measurement layer for outputting measured data of the qubit, and
the task-specific circuitry includes a parameterized quantum circuitry having an encoding gate for encoding the measured data and a quantum operation gate for performing a quantum operation according to the second parameter on the qubit, and an output layer for outputting output data representing a quantum state of the qubit.

12. A quantum-classical hybrid neural network trained for a target task, comprising:
a feature extraction circuitry that is extracted from another quantum-classical hybrid neural network trained for another task different from the target task and to which a first parameter optimized for the other task is assigned; and a task-specific circuitry that is subsequent to the feature extraction circuitry and to which a second parameter optimized for the target task is assigned, wherein
the feature extraction circuitry includes a parameterized quantum circuitry having an encoding gate for encoding classical data as an explanatory variable and a quantum operation gate for performing a quantum operation according to the first parameter on a qubit, and a measurement layer for outputting measured data of the qubit, and
the task-specific circuitry includes a parameterized quantum circuitry having an encoding gate for encoding the measured data and a quantum operation gate for performing a quantum operation according to the second parameter on the qubit, and an output layer for outputting output data representing a quantum state of the qubit.
